(19) United States
(12) Patent Application Publication
(10) Pub. No.: US 2012/0182979 A1
(43) Pub. Date: Jul. 19, 2012

(54) PERFORMANCE IN A DUAL BSS ENVIRONMENT

(75) Inventors: Ramanuja VEDANTHAM, Allen, TX (US); Assaf SELLA, Rishpon (IL); Xiaolin LU, Plano, TX (US); Ariton E. XHAFA, Plano, TX (US); Yanjun SUN, Richardson, TX (US)

(73) Assignee: TEXAS INSTRUMENTS INCORPORATED, Dallas, TX (US)

(21) Appl. No.: 13/166,454

(22) Filed: Jun. 22, 2011

Related U.S. Application Data
(60) Provisional application No. 61/433,810, filed on Jan. 18, 2011.

(51) Int. Cl. H04W 4/00

(52) U.S. Cl. 370/338

(57) ABSTRACT

An integrated circuit includes logic configured to adjust an original service time of a first Wi-Fi Basic Service Set connection (“BSS”), out of a plurality of BSSs configured to be associated with a communication device, to an adjusted service time based on an unsuccessful acknowledgement transmission or reception in a previous service time on the first BSS. At least one of the plurality of BSSs is supportive of a peer-to-peer connection.

### CROSS-REFERENCE TO RELATED APPLICATION

The present application claims priority to U.S. Provisional Patent Application No. 61/433,810, filed on Jan. 18, 2011 (Attorney Docket No. TI-70476PS); which is hereby incorporated herein by reference.

### BACKGROUND

There are more than 1 billion Wi-Fi devices in use today. Wi-Fi is widely available in homes, Wi-Fi hotspots, enterprise environments, and is found in many types of devices. The Wi-Fi Alliance has more than 350 member companies, and has completed numerous product certifications. As such, any efficiencies in Wi-Fi communication will have a wide impact.

### SUMMARY

Embodiments for efficient dual basic service set scheduling are described herein. In at least some disclosed embodiments, an integrated circuit includes logic configured to adjust an original service time of a first Wi-Fi Basic Service Set connection (“BSS”), out of a plurality of BSSs configured to be associated with a communication device, to an adjusted service time based on an unsuccessful acknowledgement transmission or reception in a previous service time on the first BSS. At least one of the plurality of BSSs is supportive of a peer-to-peer connection

In other disclosed embodiments, a method includes adjusting an original service time of a first Wi-Fi Basic Service Set connection (“BSS”), out of a plurality of BSSs configured to be associated with a communication device, to an adjusted service time based on an unsuccessful acknowledgement transmission or reception in a previous service time on the first BSS. At least one of the plurality of BSSs is supportive of a peer-to-peer connection

In yet other disclosed embodiments, a non-transitory machine-readable storage medium includes executable instructions that, when executed, cause one or more processors to adjust an original service time of a first Wi-Fi Basic Service Set connection (“BSS”), out of a plurality of BSSs configured to be associated with a communication device, to an adjusted service time based on an unsuccessful acknowledgement transmission or reception in a previous service time on the first BSS. At least one of the plurality of BSSs is supportive of a peer-to-peer connection.

These and other features and advantages will be more clearly understood from the following detailed description taken in conjunction with the accompanying drawings and claims.

### BRIEF DESCRIPTION OF THE DRAWINGS

For a more complete understanding of the present disclosure, reference is now made to the accompanying drawings and detailed description, wherein like reference numerals represent like parts:

FIG. 1 illustrates an example of specific devices in a dual BSS configuration in accordance with at least some illustrative embodiments;

FIG. 2 illustrates another example of a dual BSS configuration in accordance with at least some illustrative embodiments;

FIG. 3 illustrates a dual BSS device in accordance with at least some illustrative embodiments;

FIG. 4 illustrates BSS service time allocation in accordance with at least some illustrative embodiments;

FIG. 5 illustrates a method improving performance in a dual BSS environment in accordance with at least some illustrative embodiments; and

FIG. 6 illustrates a particular machine suitable for implementing one or more embodiments described herein.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or a direct electrical connection. Thus, if a first device couples to a second device, that connection may be through a direct electrical connection, or through an indirect electrical connection via other devices and connections.

The terms “computer readable medium” or “machine readable medium” as referred to herein relates to non-transitory media capable of maintaining expressions that are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium, and embodiments are not limited in this respect.

The term “logic” as referred to herein relates to structure for performing one or more logical operations. For example, logic may comprise circuitry that provides one or more output signals based upon one or more input signals. Such circuitry may comprise a finite state machine, which receives a digital input and provides a digital output, or circuitry, which provides one or more analog output signals in response to one or more analog input signals. Such circuitry may be provided in an application specific integrated circuit (“ASIC”) or field programmable gate array (“FPGA”). Also, logic may comprise machine-readable instructions stored in a memory in combination with processing circuitry to execute such machine-readable instructions. However, these are merely examples of structures that may provide logic, and embodiments are not limited in this respect.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Wi-Fi Direct devices connect in a way that makes it convenient for users to print, share, and display files. Wi-Fi Direct devices connect directly to one another without access to traditional network infrastructure such as stations (“STAs”) or access points (“APs”). As such, mobile phones, cameras, printers, computers, gaming devices, and the like can connect to each other directly to transfer content and share applications without network infrastructure. Devices can make a one-to-one connection, or a group of several devices can connect simultaneously. The devices can connect for a single exchange, or the devices can retain the memory of the connection and link together each time the devices are in proximity.

Wi-Fi Direct is also known as Wi-Fi Peer-to-Peer (“P2P”), and the Wi-Fi Peer to Peer Technical Specification, Version 1.0.14, Wi-Fi Alliance Technical Committee, P2P Task Group, 2010 is incorporated by reference as if fully reproduced herein. A Wi-Fi Direct device is capable of peer-to-peer connections as well as infrastructure connections. Wi-Fi Direct devices connect by forming Groups in a one-to-one or one-to-many topology. A single Wi-Fi Direct device is in charge of the Group including controlling which devices are allowed to join the Group and when the Group is terminated. This Group Master will appear as an access point (“AP”) to legacy devices. The Group Master is not an AP, but it provides some of the services commonly provided by an AP. Examples include BSS functionality, Wi-Fi Protected Setup Internal Registrar functionality, and communication management between clients in the Group. Any Wi-Fi Direct device is capable of being Group Master, and is able to negotiate with other Wi-Fi Direct devices as to which device will be the Group Master. A Group may include both Wi-Fi Direct devices and legacy devices (i.e., Wi-Fi certified devices that are not compliant with the Wi-Fi Alliance Peer-to-Peer Specification).

Wi-Fi Direct devices also support discovery, power management, managed device mechanisms, and concurrent infrastructure connections. Device discovery scans for and identifies other Wi-Fi Direct devices in order to establish a connection. Users can select a discovered device for connection, and if the discovered device is not already part of a Group, a new Group is formed. If the discovered device is already part of a Group, the scanning Wi-Fi Direct device may attempt to join the existing Group. Wi-Fi protected setup obtains credentials and authenticates the scanning Wi-Fi Direct device.

Service discovery enables the advertisement of services supported by higher layer applications (e.g., Bonjour, UPnP, and Web Service Discovery) to Wi-Fi Direct devices. Service discovery can be performed at any time (e.g. even before a connection is formed) with any other discovered Wi-Fi Direct device. For example, if a user wishes to print a photo, the printing application can identify which Wi-Fi Direct devices provide printing services and can present a compatible list of options to the user. As such, a camera can query to determine if Wi-Fi Direct devices are printers.

After a Group is formed, a Wi-Fi Direct device may invite another Wi-Fi Direct device to join the Group. The invited device may decline, accept, or ignore the invitation. Groups may be re-invoked for additional sessions after initial formation, and invitations can also be used to request that a previously used persistent Group be reformed. For example, a laptop could create a persistent Group comprised of the laptop and a printer. Persistent Groups may be restarted without provisioning, thus eliminating the need to repeat tasks such as entering a Wi-Fi Protected Setup PIN. Similarly, Wi-Fi Direct devices can store other persistent Group information and credentials.

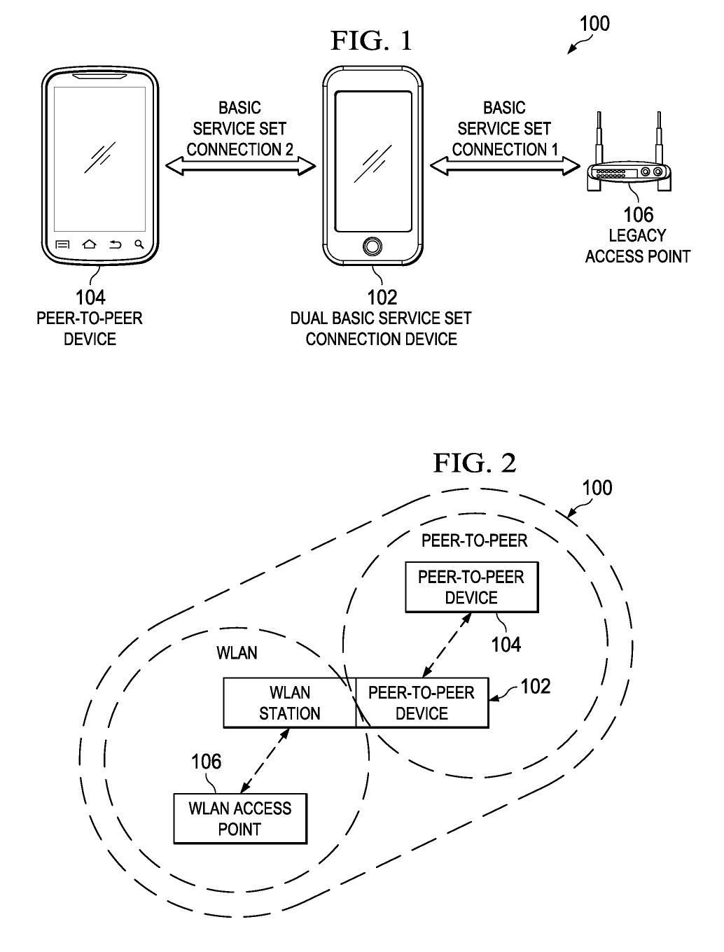

A Wi-Fi Direct Device that can be in a Group while maintaining a network infrastructure connection at the same time is a concurrent device or dual basic service set connection (“BSS”) device. A BSS is a set of stations and/or access points that have successfully synchronized using WLAN. Membership in a BSS does not imply that wireless communication with all other members of the BSS is possible. BSS may also refer to the channels, bands, etc. on which the devices communicate. For example, FIG. 1 illustrates a dual BSS device 102. The dual BSS device 102 has an established connection (BSS1) with a legacy AP 106 and another established connection (BSS2) with P2P device 104. As such, BSS2 supports a P2P connection and operates concurrently with BSS1. BSS1 is a TCP/FTP connection in at least one embodiment. The devices 102, 104, 106 and the BSSs make up the network 100. FIG. 2 illustrates that the network 100 can include two subnetworks. The P2P subnetwork includes P2P device 104, dual BSS device 102, and BSS2. The WLAN subnetwork includes legacy AP 106, dual BSS device 102, and BSS1. Concurrent connections may be supported by a single transceiver in the dual BSS device 102, and may support connections on different channels.

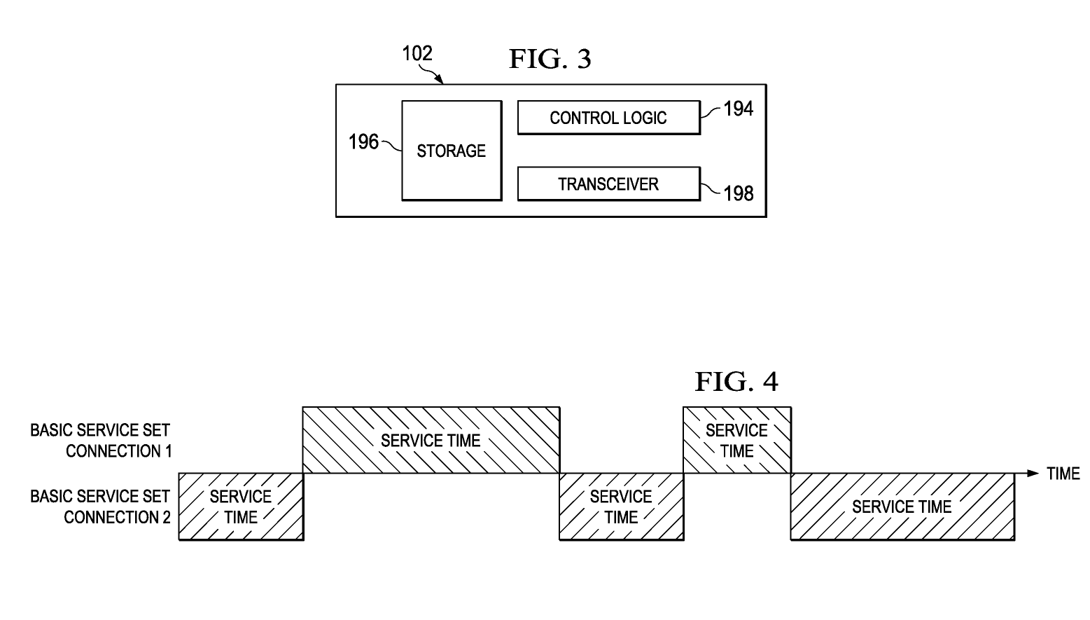

FIG. 3 illustrates the dual BSS device 102 in at least some embodiments. The device 102 includes non-transitory storage 196, a transceiver 198, and control logic 194. The control logic 194 comprises a processor or application specific integrated circuit (“ASIC”) in various embodiments. Any or all of the components may be coupled in at least some embodiments. The transceiver 198 may include an antenna and logic configure to process incoming and outgoing traffic. The storage 196 may include general or dedicated random access memory or non-volatile storage (e.g., read-only memory, flash storage, etc.). The control logic 194 can execute any action described herein. Specifically, instructions and software can be executed.

FIG. 4 illustrates service times in at least some embodiments. If the BSSs share the transceiver 198, then some dedicated time is allotted for each BSS to access the transceiver 198 to prevent both BSSs from accessing the wireless medium simultaneously. This dedicated time is referred to as the service time. A BSS within its assigned service time is an active BSS, while a BSS outside of its assigned service time is an inactive BSS. FIG. 4 illustrates that BSS1 and BSS2 alternate service times. However, it is inefficient for each service time to be the same length, especially if the service time is unneeded or not available when needed.

Different networks and protocols allow for different acknowledgement behavior. For example, in a transmission control protocol (“TCP”) network with a 2 to 1 acknowledgment policy, there will be an acknowledgment packet (“ACK”) sent for every two packets successfully received. An ACK is any type of packet that signifies that a previous packet has been received. In many scenarios, the default service time for a BSS, e.g. BSS1, allows for the reception and transmission of packets but not the corresponding ACK. Specifically, if the dual BSS device 102 is to send two packets and receive an ACK on BSS1, the packets are sent during the service time for BSS1, but the ACK is sent, by e.g. AP 106, during the service time for BSS2. By missing ACK reception within the service time for BSS1, the dual BSS device 102 can err in multiple ways. The device 102 may ignore other packets that are not the expected ACK, the device 102 may retransmit the two packets after concluding that the transmission failed because the expected ACK was not received, and the like. Due to these types errors, the service time scheduled for BSS1 will not expand proportionally to the amount of traffic, which causes other errors such as congestion, dropped packets, and the like. As such, throughput degrades for BSS1. Similarly, service time may also prevent dual BSS device 102 from transmitting an ACK correctly.

The control logic 194 includes logic configured to adjust service times to accommodate the time taken for ACK reception or transmission. Also, the logic is configured to adjust service times during sensitive periods of transmissions such as slow starts. At the beginning of a connection, the dual BSS device 102 does not know many variables necessary to optimize the connection such as connection type, rate, requirements, and the like. As such, during a slow-start period, for every TCP ACK received, the service time is doubled. As such, the adjusted service time reaches a steady state much faster, and the service time will be adjusted less.

The control logic 194 includes logic configured to adjust an original service time of a first BSS (e.g. BSS1) out of a plurality of BSSs (e.g. BSS1 and BSS2) configured to be associated with a communication device (e.g. dual BSS device 102), to an adjusted service time based on an unsuccessful TCP ACK transmission or reception in a previous service time on BSS1. The original service time is a service time that is predicted or scheduled to occur. If no service time is predicted or scheduled to occur, then adjusting the original service time means scheduling the current service time to accommodate predicted or scheduled packets on any BSS. For example, if a 2 to 1 policy is in place, and the dual BSS device 102 sent two packets during the last service time, but did not receive an expected ACK in the last service time, the current service time will be expanded.

In at least one embodiment, the logic is configured to adjust the original service time by increasing the original service time of BSS1 such that the acknowledgement will be transmitted or received on BSS1 within the adjusted service time. The adjusted service time is equal to a predetermined time in at least one embodiment. Thresholds may be implemented to ensure that one factor does not dominate and cause BSS2 to starve. For example, a minimum BSS service time threshold and a maximum BSS service time threshold ensures a minimum quality of service for each BSS in at least one embodiment. Depending on network needs, the adjustment may be incremental (e.g. expand the service time by an incremental amount of time such as 5 milliseconds per subsequent service time until the threshold is reached) or absolute (e.g. expand the service time to a predetermined maximum instantly). In at least one embodiment, the predetermined maximum is 19 milliseconds.

In at least one embodiment, before adjusting service times the logic is configured to identify that a TCP dialogue has begun. For example, the logic is configured to identify a packet on BSS1 as having TCP format by inspecting a header of the packet. BSS1 may implement a file transfer protocol (“FTP”) session, a World Wide Web browsing session, or email session using TCP in at least some embodiments. For a FTP session, it is desirable to maintain high throughput during the entire course of the TCP session.

Additional factors may contribute to the adjustment of service time such as packets in a queue associated with the previous service time or current service time. For example, if packets in the queue were not sent during the previous service time, the current service time is expanded proportionally to the size or number of packets in the queue. Also, the factors may be tiered or weighted to provide additional guidance as to how much of an impact each factor will have on service time. In at least one embodiment, the logic is configured to adjust the original service time while the first BSS is active. In other embodiments, calculation and adjustment of the service time occur as necessary no matter which BSS is active. Additionally, a formula may be used to determine the adjustment.

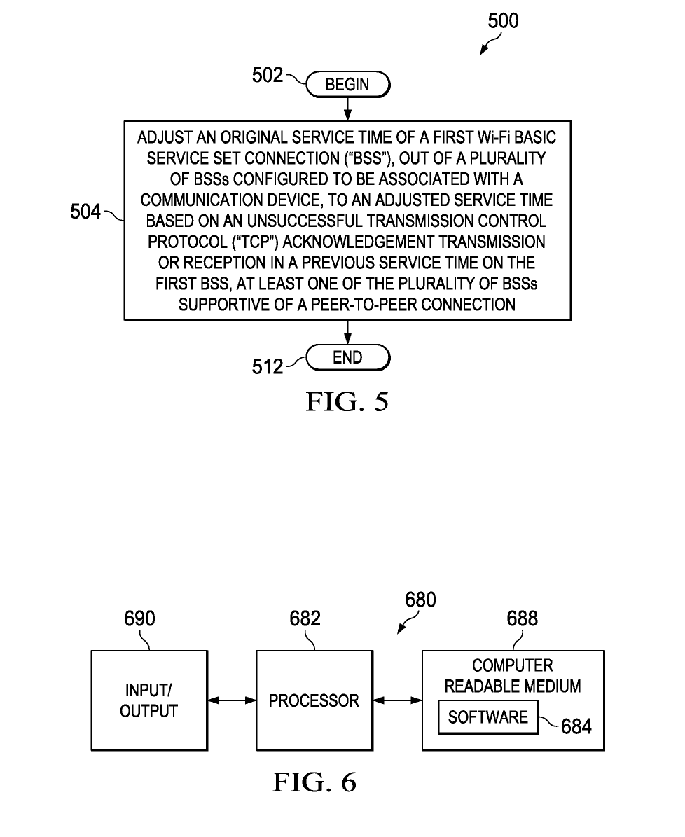

Another way to combine the factors is to adjust service times according to an algorithm. For example, upon detecting a TCP transmission, the service time is adjusted for a slow start period and retransmissions. Specifically, TCP synchronization frames are detected at the start of the session. Next, traffic pattern and queue size will dictate further adjustments. FIG. 5 illustrates a method 500 of improving performance in a dual BSS environment beginning at 502 and ending at 506. At 504 an original service time of a first BSS, out of a plurality of BSSs configured to be associated with a communication device, is adjusted to an adjusted service time based on an unsuccessful TCP ACK transmission or reception in a previous service time on the first BSS. At least one of the plurality of BSSs is supportive of a peer-to-peer connection. In at least one embodiment, the original service time is adjusted by increasing the original service time of the first BSS such that the acknowledgement will be transmitted or received on the first BSS within the adjusted service time. The original service time is adjusted by increasing the original service time of the first BSS such that the adjusted service time is equal to a predetermined time in at least one embodiment. In various embodiments, the method 500 further includes identifying a packet on the first BSS as having TCP format by inspecting a header of the packet. Such a header may indicate that the first BSS implements a file transfer protocol (“FTP”) session or a World Wide Web browsing session.

In at least one embodiment, the original service time of the first BSS is adjusted based on a queue associated with the previous service time. The original service time is adjusted while the first BSS is active in at least one embodiment. In various embodiments, the original service time is adjusted based on various combinations of previous service times, current service times, transmit traffic, and receive traffic.

The system described above may be implemented on any particular machine or computer with sufficient processing power, memory resources, and throughput capability to handle the necessary workload placed upon the computer. FIG. 6 illustrates a particular computer system 680 suitable for implementing one or more embodiments disclosed herein. The computer system 680 includes a processor 682 (which may be referred to as a central processor unit or CPU) that is in communication with memory devices including storage 688, and input/output (I/O) 690 devices. The processor may be implemented as one or more CPU chips or an ASIC. In various embodiments, the storage 688 comprises a computer-readable medium such as volatile memory (e.g., RAM), non-volatile storage (e.g., Flash memory, hard disk drive, CD ROM, etc.), or combinations thereof. The storage 688 comprises software 684 that is executed by the processor 682. One or more of the actions described herein are performed by the processor 682 during execution of the software 684.

Embodiments of the present invention may be implemented in the form of software, hardware, application logic, or a combination of software, hardware, and application logic. The software, application logic and/or hardware may reside on integrated circuit chips, modules, or memories. If desired, part of the software, hardware and/or application logic may reside on integrated circuit chips, part of the software, hardware and/or application logic may reside on modules, and part of the software, hardware and/or application logic may reside on memories. In one exemplary embodiment, the application logic, software or an instruction set is maintained on any one of various conventional non-transitory machine-readable media.

Processes and logic flows which are described in this specification can be performed by one or more programmable processors executing one or more computer programs to perform functions by operating on input data and generating output. Processes and logic flows can also be performed by special purpose logic circuitry, e.g., an FPGA (field programmable gate array) or an ASIC (application-specific integrated circuit). Apparatus or devices which are described in this specification can be implemented by a programmable processor, a computer, a system on a chip, or combinations of them, by operating on input date and generating output. Apparatus or devices can include special purpose logic circuitry, e.g., an FPGA or an ASIC. Apparatus or devices can also include, in addition to hardware, code that creates an execution environment for computer program, e.g., code that constitutes processor firmware, a protocol stack, a database management system, an operating system, a cross-platform runtime environment, e.g., a virtual machine, or a combination of one or more of them.

Generally, a processor will receive instructions and data from a read-only memory or a random access memory or both. The elements of a computer generally include a processor for performing or executing instructions, and one or more memory devices for storing instructions and data. Machine-readable media may include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. A computer program (also known as, e.g., a program, software, software application, script, or code) can be written in any programming language, including compiled or interpreted languages, declarative or procedural languages, and it can be deployed in any form, including as a stand-alone program or as a module, component, subroutine, object, or other unit suitable for use in a computing environment. A computer program can be deployed to be executed on one computer or on multiple computers that are located at one single site or distributed across multiple sites and interconnected by a communication network.

Certain features that are described in the context of separate embodiments can also be combined and implemented as a single embodiment. Conversely, various features that are described in the context of a single embodiment can also be implemented in multiple embodiments separately or in any suitable subcombinations. Moreover, although features may be described as acting in certain combinations and even initially claimed as such, one or more features from a combination as described or a claimed combination can in certain cases be excluded from the combination, and the claimed combination may be directed to a subcombination or variation of a subcombination. Although various aspects of the invention are set out in the independent claims, other aspects of the invention comprise other combinations of features from the embodiments and/or from the dependent claims with the features of the independent claims, and not solely the combinations explicitly set out in the claims. Certain functions that are described in this specification may be performed in a different order and/or concurrently with each other. Furthermore, if desired, one or more of the above-described functions may be optional or may be combined.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications. Additionally, audio or visual alerts may be triggered upon successful completion of any action described herein, upon unsuccessful actions described herein, and upon errors.

What is claimed is:

1. An integrated circuit, comprising:
logic configured to adjust an original service time of a first Wi-Fi Basic Service Set connection (“BSS”), out of a plurality of BSSs configured to be associated with a communication device, to an adjusted service time based on an unsuccessful acknowledgement transmission or reception in a previous service time on the first BSS;
wherein at least one of the plurality of BSSs is supportive of a peer-to-peer connection.

2. The integrated circuit of claim 1, wherein the logic is configured to adjust the original service time by increasing the original service time of the first BSS such that the acknowledgement will be transmitted or received on the first BSS within the adjusted service time.

3. The integrated circuit of claim 1, wherein the logic is configured to adjust the original service time by increasing the original service time of the first BSS such that the adjusted service time is equal to a predetermined time.

4. The integrated circuit of claim 1, wherein the logic is configured to identify a packet on the first BSS as having transmission control protocol (“TCP”) format by inspecting a header of the packet.

5. The integrated circuit of claim 1, wherein the first BSS implements a file transfer protocol (“FTP”) session.

6. The integrated circuit of claim 1, wherein the first BSS implements a World Wide Web browsing session or email session.

7. The integrated circuit of claim 1, wherein the logic is further configured to adjust the original service time of the first BSS based on a queue associated with the previous service time.

8. The integrated circuit of claim 1, wherein the logic is configured to adjust the original service time while the first BSS is active.

9. An method comprising:
adjusting an original service time of a first Wi-Fi Basic Service Set connection (“BSS”), out of a plurality of BSSs configured to be associated with a communication device, to an adjusted service time based on an unsuccessful acknowledgement transmission or reception in a previous service time on the first BSS, at least one of the plurality of BSSs supportive of a peer-to-peer connection.

10. The method of claim 9, further comprising adjusting the original service time by increasing the original service time of the first BSS such that the acknowledgement will be transmitted or received on the first BSS within the adjusted service time.

11. The method of claim 9, further comprising adjusting the original service time by increasing the original service time of the first BSS such that the adjusted service time is equal to a predetermined time.

12. The method of claim 9, further comprising identifying a packet on the first BSS as having transmission control protocol (“TCP”) format by inspecting a header of the packet.

13. The method of claim 9, the first BSS implementing a file transfer protocol (“FTP”) session.

14. The method of claim 9, the first BSS implementing a World Wide Web browsing session or email session.

15. The method of claim 9, further comprising adjusting the original service time of the first BSS based on a queue associated with the previous service time.

16. The method of claim 9, further comprising adjusting the original service time while the first BSS is active.

17. A non-transitory machine-readable storage medium comprising executable instructions that, when executed, cause one or more processors to:
adjust an original service time of a first Wi-Fi Basic Service Set connection (“BSS”), out of a plurality of BSSs configured to be associated with a communication device, to an adjusted service time based on an unsuccessful acknowledgement transmission or reception in a previous service time on the first BSS, at least one of the plurality of BSSs supportive of a peer-to-peer connection.

18. The medium of claim 17, wherein the one or more processors are further caused to adjust the original service time by increasing the original service time of the first BSS such that the acknowledgement will be transmitted or received on the first BSS within the adjusted service time.

19. The medium of claim 17, wherein the one or more processors are further caused to adjust the original service time by increasing the original service time of the first BSS such that the adjusted service time is equal to a predetermined time.

20. The medium of claim 17, wherein the one or more processors are further caused to adjust the original service time of the first BSS based on a queue associated with the previous service time.
